(19) United States
(12) Patent Application Publication
(10) Pub. No.: US 2011/0172941 A1
(43) Pub. Date: Jul. 14, 2011

(54) SCREENING APPARATUS, SCREENING METHOD, AND PROGRAM

(75) Inventor: Kazuhiro SAKAGUCHI, Kanagawa (JP)

(73) Assignee: RENESAS ELECTRONICS CORPORATION, Kanagawa (JP)

(21) Appl. No.: 13/005,972

(22) Filed: Jan. 13, 2011

(30) Foreign Application Priority Data
Jan. 14, 2010 (JP) 2010-005920

(51) Int. Cl. G06F 19/00

(52) U.S. Cl. 702/83

(57) ABSTRACT

A screening apparatus includes: a measurement unit measuring characteristics of a semiconductor device and reading an identification code allocated to the semiconductor device; a database storing a table representing a correspondence between an identification code and a fabrication condition of a semiconductor device; a conversion unit extracting, based on the identification code sent from the measurement unit, a corresponding fabrication condition from the database and associating the extracted fabrication condition with the characteristics corresponding to the fabrication condition; a characteristics reconstruction unit classifying the characteristics according to the fabrication condition sent from the conversion unit; and an evaluation and analysis unit evaluating and analyzing the characteristics classified by the characteristics reconstruction unit according to the fabrication condition in a predetermined manner and determining a semiconductor device to be screened.

### TECHNICAL FIELD

### Reference to Related Application

This application is based upon and claims the benefit of the priority of Japanese patent application No. 2010-005920, filed on Jan. 14, 2010, the disclosure of which is incorporated herein in its entirety by reference thereto.

The present invention relates to a screening apparatus, a screening method, and a program for screening integrated circuits. In particular, it relates to a screening apparatus, a screening method, and a program for screening integrated circuits each having unique characteristics.

### BACKGROUND

Conventionally, integrated-circuit screening apparatuses are used for screening semiconductor devices manufactured on semiconductor wafers to determine defective devices.

For example, based on a screening apparatus disclosed in Patent Document 1, as illustrated in FIG. 13, a large scale integration (LSI) tester 101 is electrically connected to devices under test (DUTs) on wafers 104 via a probe 102 and tests the DUTs (performs various types of measurement on the DUTs, obtains physical values of the DUTs, and determines quality of the DUTs). As a result of the test, regarding the DUTs determined to be non-defective, the LSI tester 101 stores physical values measured during the test, such as voltage values and current values, in a data file 103, along with information about intra-wafer positions of the DUTs. After the LSI tester 101 tests all the DUTs on the wafers 104, the calculator 105 reads the physical values from the data file 103 based on determination programs stored in a recording medium 107 and inspects a distribution of the physical values. Consequently, based on predetermined criteria, the calculator 105 determines DUTs each exhibiting physical values that deviate from the distribution and outputs positional coordinates of the DUTs as results 106.

Patent Document 1: Japanese Patent Kokai Publication No. JP-P2008-2900A (FIG. 1)

### SUMMARY

The entire disclosure of above Patent Document 1 is incorporated herein by reference thereto. The following analysis has been given by the present invention.

However, when such a conventional screening apparatus screens semiconductor devices assembled (manufactured) from cut-out semiconductor devices (chips), instead of from semiconductor devices (chips) on a semiconductor wafer, high-precision screening may not be possible.

This is because, since measured values of a semiconductor device (DUT) are highly sensitive to conditions under which the semiconductor device is manufactured, if manufacturing conditions are different, distribution of measured values is also greatly varied. Namely, since semiconductor devices (chips) on a single semiconductor wafer are manufactured under the same manufacturing conditions, a distribution of measured values of the semiconductor devices (chips) on the semiconductor wafer falls within a narrow range. However, if semiconductor devices (chips) are manufactured from different semiconductor wafers, the manufacturing conditions of the semiconductor devices cannot be identical. Thus, a distribution of measured values of each of the semiconductor devices varies and spreads in a certain wide range. As described above, based on the screening technique, if a semiconductor device exhibits measured values that deviate from a distribution, the semiconductor device is determined to be defective. This screening technique is effective if semiconductor devices from a single semiconductor wafer having the same manufacturing conditions are screened. However, if semiconductor devices from different semiconductor wafers having different manufacturing conditions are screened, the above screening technique is not effective at all. Normally, a plurality of semiconductor devices of a single lot (product unit) include semiconductor devices manufactured from semiconductor devices (chips) on different semiconductor wafers, and a distribution of the measured values often spreads in a wide range. Therefore, the technique of detecting outliers from such distribution and determining quality of semiconductor devices may not enable high-precision screening. Thus there is much to be desired in the art.

It is an object of the present invention to provide a screening apparatus, a screening method, and a program that enable high-precision screening even when semiconductor devices manufactured under different manufacturing conditions are screened.

In a first aspect of the present invention, there is provided a screening apparatus comprising: a measurement unit measuring characteristics of a semiconductor device and reading an identification code allocated to the semiconductor device; a database storing a table representing a correspondence between an identification code and a fabrication condition of a semiconductor device; a conversion unit extracting, based on the identification code sent from the measurement unit, a fabrication condition associated with the identification code from the database and associating the extracted fabrication condition with the characteristics corresponding to the fabrication condition; a characteristics reconstruction unit classifying the characteristics according to the fabrication condition sent from the conversion unit; and an evaluation and analysis unit evaluating and analyzing the characteristics classified by the characteristics reconstruction unit according to the fabrication condition in a predetermined manner and determining a semiconductor device to be screened.

It is preferable that the screening apparatus according to the present invention further include: an inverse conversion unit extracting, based on the fabrication condition of the semiconductor device to be screened determined by the evaluation and analysis unit, a corresponding identification code associated with the fabrication condition from the database and outputting the extracted identification code.

Based on the screening apparatus according to the present invention, it is preferable that the conversion unit associate the extracted fabrication condition with the characteristics and the identification code corresponding to the extracted fabrication condition and the characteristics reconstruction unit classify the characteristics and the identification code according to the fabrication condition.

Based on the screening apparatus according to the present invention, it is preferable that the measurement unit include a measurement apparatus measuring characteristics of the semiconductor device and a reader reading an identification code allocated to the semiconductor device.

Based on the screening apparatus according to the present invention, it is preferable that the evaluation and analysis unit analyze the characteristics classified according to the fabrication conditions and determine a semiconductor device exhibiting characteristics that deviate from a distribution to be a semiconductor device to be screened.

Based on the screening apparatus according to the present invention, it is preferable that at least the conversion unit, the characteristics reconstruction unit, and the evaluation and analysis unit be realized by a calculator executing a program.

It is preferable that the screening apparatus according to the present invention further include a second database storing characteristics and a fabrication condition of a past semiconductor device and the characteristics reconstruction unit send the characteristics and the fabrication condition sent from the conversion unit to the second database and update data in the second database.

Based on the screening apparatus according to the present invention, it is preferable that the characteristics reconstruction unit extract necessary data from the second database and classify the characteristics according to the fabrication condition based on the extracted necessary data.

In a second aspect of the present invention, there is provided a screening method comprising: measuring characteristics of a semiconductor device and reading an identification code allocated to the semiconductor device; extracting, based on the read identification code, a fabrication condition associated with the identification code from a database storing a table representing a correspondence between an identification code and a fabrication condition of a semiconductor device and associating the extracted fabrication condition with the characteristics corresponding to the fabrication condition; classifying the characteristics according to the fabrication condition; and evaluating and analyzing the characteristics classified according to the fabrication condition in a predetermined manner and determining a semiconductor device to be screened.

It is preferable that the screening method of the present invention further include adding the characteristics and the fabrication condition to the second database between associating the fabrication condition with the characteristics corresponding to the fabrication condition and classifying the characteristics.

In a third aspect of the present invention, there is provided a program that causes a calculator (or computer) to execute: measuring characteristics of a semiconductor device, reading an identification code allocated to the semiconductor device, extracting, based on the read identification code, a fabrication condition associated with the identification code from a database storing a table representing a correspondence between an identification code and a fabrication condition of a semiconductor device, and associating the extracted fabrication condition with the characteristics corresponding to the fabrication condition; classifying the characteristics according to the fabrication condition; and evaluating and analyzing the characteristics classified according to the fabrication condition in a predetermined manner and determining a semiconductor device to be screened.

It is preferable that the program of the present invention cause the calculator (or computer) to execute adding the characteristics and the fabrication condition to the second database between associating the fabrication condition with the characteristics corresponding to the fabrication condition and classifying the characteristics.

The meritorious effects of the present invention are summarized as follows.

According to the present invention, even when semiconductor devices manufactured under different fabrication conditions (manufacturing conditions) are screened, high-precision screening can be executed. This is because, since various characteristics of a semiconductor device are highly sensitive to fabrication conditions (manufacturing conditions), if a single lot includes semiconductor devices manufactured under many different fabrication conditions (manufacturing conditions), a distribution of characteristics (measured values) of the semiconductor devices naturally spreads in a wide range. Thus, based on a conventional screening apparatus that simply determines a semiconductor device exhibiting characteristics (measured values) that deviate from a distribution to be defective, it is difficult to determine whether the measured values deviate from a distribution. However, if fabrication conditions (manufacturing conditions) are classified, a distribution of characteristics (measured values) falls within a certain narrow range, outliers of the distribution can easily be determined. Namely, if fabrication conditions (manufacturing conditions) are extracted based on identification codes (IDs) of semiconductor devices and a distribution of characteristics (measured values) is created for the corresponding fabrication conditions (manufacturing conditions), the distribution of characteristics (measured values) falls within a certain narrow range. Thus, a semiconductor device having characteristics (measured values) that deviate from a distribution can easily be determined.

### BRIEF DESCRIPTION OF THE DRAWINGS

FIG. 1 is a block diagram schematically illustrating a configuration of a screening apparatus according to example 1 of the present invention.

FIG. 2 is a flow chart schematically illustrating an operation of the screening apparatus according to example 1 of the present invention.

FIG. 3 is a block diagram schematically illustrating a configuration of a screening apparatus according to example 2 of the present invention.

FIG. 4 is a block diagram schematically illustrating an internal configuration of a calculator of the screening apparatus according to example 2 of the present invention.

FIG. 5 is a flow chart schematically illustrating an operation of the screening apparatus according to example 2 of the present invention.

FIG. 6 is a block diagram schematically illustrating a configuration of a screening apparatus according to example 3 of the present invention.

FIG. 7 is a block diagram schematically illustrating an internal configuration of a calculator of a screening apparatus according to example 4 of the present invention.

FIG. 8 is a block diagram schematically illustrating a configuration of a screening apparatus according to example 5 of the present invention.

FIG. 9 is a flow chart schematically illustrating an operation of the screening apparatus according to example 5 of the present invention.

FIG. 10 is a block diagram schematically illustrating a configuration of a screening apparatus according to example 6 of the present invention.

FIG. 11 is a block diagram schematically illustrating an internal configuration of a calculator of the screening apparatus according to example 6 of the present invention.

FIG. 12 is a flow chart schematically illustrating an operation of the screening apparatus according to example 6 of the present invention.

FIG. 13 is a block diagram schematically illustrating a configuration of a screening apparatus according to a conventional example.

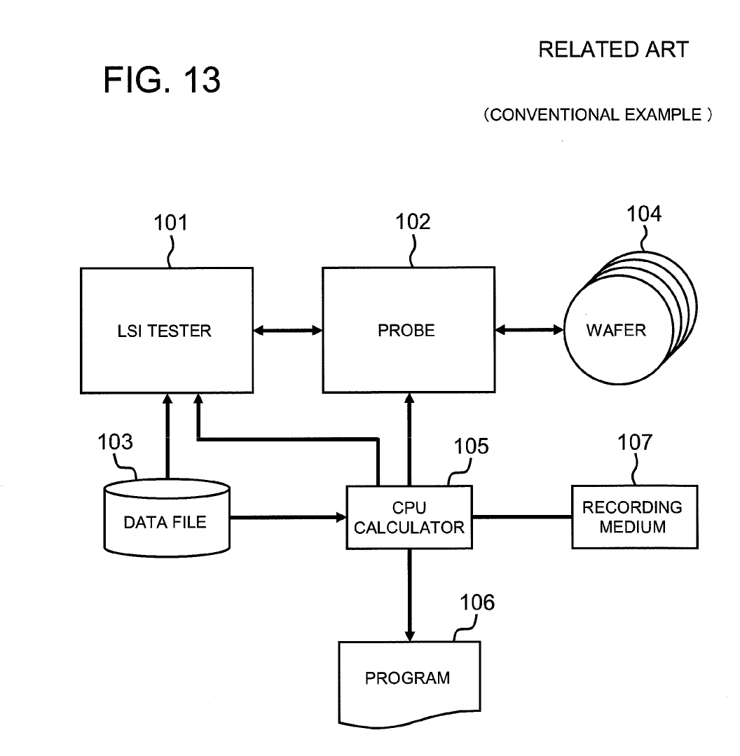

### PREFERRED MODES

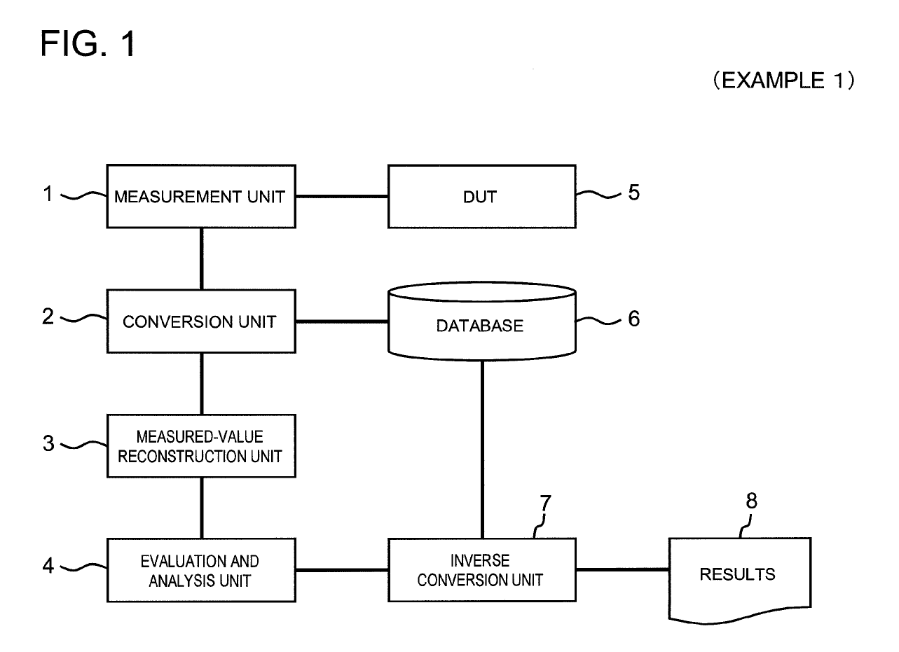

A screening apparatus according to exemplary embodiment 1 of the present invention includes: a measurement unit (1 of FIG. 1) measuring characteristics of a semiconductor device (5 of FIG. 1) and reading an identification code allocated to the semiconductor device; a database (6 of FIG. 1) storing a table representing a correspondence between an identification code and a fabrication condition of a semiconductor device; a conversion unit (2 of FIG. 1) extracting, based on the identification code sent from the measurement unit, a fabrication condition associated with the identification code from the database and associating the extracted fabrication condition with the characteristics corresponding to the fabrication condition; a characteristics reconstruction unit (3 of FIG. 1) classifying the characteristics according to the fabrication condition sent from the conversion unit; and an evaluation and analysis unit (4 of FIG. 1) evaluating and analyzing the characteristics classified by the characteristics reconstruction unit according to the fabrication condition in a predetermined manner and determining a semiconductor device to be screened.

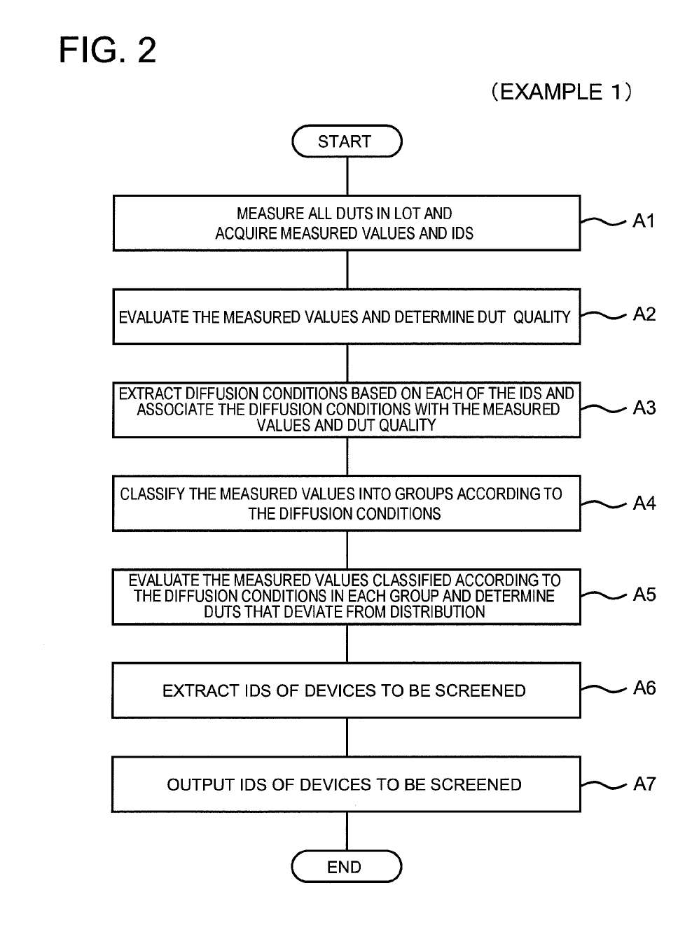

A screening method according to exemplary embodiment 2 of the present invention includes: measuring characteristics of a semiconductor device and reading an identification code allocated to the semiconductor device (step A1 of FIG. 2); extracting, based on the read identification code, a fabrication condition associated with the identification code from a database storing a table representing a correspondence between an identification code and a fabrication condition of a semiconductor device and associating the extracted fabrication condition with the characteristics corresponding to the fabrication condition (step A3 of FIG. 2); classifying the characteristics according to the fabrication condition (step A4 of FIG. 2); and evaluating and analyzing the characteristics classified according to the fabrication condition in a predetermined manner and determining a semiconductor device to be screened (step A5 of FIG. 2).

A program according to exemplary embodiment 3 of the present invention causes a calculator to execute: measuring characteristics of a semiconductor device, reading an identification code allocated to the semiconductor device, extracting, based on the read identification code, a fabrication condition associated with the identification code from a database storing a table representing a correspondence between an identification code and a fabrication condition of a semiconductor device, and associating the extracted fabrication condition with the characteristics corresponding to the fabrication condition (step A3 of FIG. 2); classifying the characteristics according to the fabrication condition (step A4 of FIG. 2); and evaluating and analyzing the characteristics classified according to the fabrication condition in a predetermined manner and determining a semiconductor device to be screened (step A5 of FIG. 2).

Note that the reference symbols mentioned in the above description of the exemplary embodiments are intended merely for better understanding and illustration and should not be regarded as limitative. In the following examples are described with reference to the Drawings.

### EXAMPLE 1

A screening apparatus according to example 1 of the present invention will be described with reference to the drawings. FIG. 1 is a block diagram schematically illustrating a configuration of the screening apparatus according to example 1 of the present invention.

In FIG. 1, the screening apparatus according to example 1 screens integrated circuits of devices under test (DUTs) 5 (semiconductor devices) and includes a measurement unit 1, a conversion unit 2, a measured-value reconstruction unit 3, an evaluation and analysis unit 4, an inverse conversion unit 7, and a database 6, as main components.

The measurement unit 1 measures characteristics such as an output signal, an output voltage, and an output current from integrated circuits of the DUTs 5. The measurement unit 1 can be electrically connected to the DUTs 5 (terminals thereof) via a probe or the like and can apply an appropriate signal, voltage, and current to the DUTs 5. Further, the measurement unit 1 can set operation environments (the temperature, etc.) of the DUTs 5. By measuring values (physical values) such as an output signal, an output voltage, and an output current from the DUTs 5 under such environments, the measurement unit 1 evaluates the measured values (physical values) of the DUTs 5, and based on results of the evaluation, determines quality of each of the DUTs 5 of a lot. In addition, when evaluating and determining the DUTs 5, the measurement unit 1 can read an identification code (ID) uniquely allocated to each of the DUTs 5. The measurement unit 1 is connected to the conversion unit 2, so that the measurement unit 1 can communicate with the conversion unit 2. The measurement unit 1 sends the measured values (physical values such as current values, voltage values, and frequencies) obtained during the inspection of the DUTs 5 to the conversion unit 2, along with the IDs and the determination results.

The conversion unit 2 converts the inputted IDs into corresponding diffusion conditions. Namely, based on the IDs sent from the measurement unit 1, the conversion unit 2 extracts diffusion conditions associated with the IDs from the database 6. The conversion unit 2 is connected to the database 6 (a storage unit (not illustrated) storing the database 6) and the measured-value reconstruction unit 3, so that the conversion unit 2 can communicate with the database 6 and the measured-value reconstruction unit 3. The conversion unit 2 associates the extracted diffusion conditions with corresponding measured values (physical values), determination results, and IDs and sends these associated data to the measured-value reconstruction unit 3.

The measured-value reconstruction unit 3 reconstructs the inputted measured values based on the diffusion conditions. Namely, based on the diffusion conditions sent from the conversion unit 2, the measured-value reconstruction unit 3 classifies (groups) the measured values (physical values) and the determination results sent from the conversion unit 2 according to the diffusion conditions. The measured-value reconstruction unit 3 is connected to the conversion unit 2 and the evaluation and analysis unit 4, so that the measured-value reconstruction unit 3 can communicate with the units 2 and 4. The measured-value reconstruction unit 3 sends the measured values (physical values) and the determination results classified according to the diffusion conditions to the evaluation and analysis unit 4.

The evaluation and analysis unit 4 analyzes the inputted determination results and measured values (physical values) classified according to the diffusion conditions and evaluates whether each of the DUTs 5 exhibits measured values (physical values) that deviate from a distribution. Namely, the evaluation and analysis unit 4 analyzes the determination results and the measured values (physical values) that are classified according to the diffusion conditions and that are sent from the measured-value reconstruction unit 3 and determines DUTs 5 each exhibiting measured values (physical values) that deviate from a distribution. The evaluation and analysis unit 4 is connected to the measured-value reconstruction unit 3 and the inverse conversion unit 7, so that the evaluation and analysis unit 4 can communicate with these units 3 and 7. The evaluation and analysis unit 4 sends DUT information (including diffusion conditions, determination results, and physical values) about the DUTs 5 each exhibiting measured values (physical values) that deviate from a distribution to the inverse conversion unit 7.

The inverse conversion unit 7 converts the inputted diffusion conditions into corresponding IDs. Namely, based on the DUT information sent from the evaluation and analysis unit 4, the inverse conversion unit 7 extracts corresponding IDs from the database 6. The inverse conversion unit 7 is connected to the evaluation and analysis unit 4 and the database 6 (a storage unit (not illustrated) storing the database 6), so that the inverse conversion unit 7 can communicate with these units 4 and 6. The inverse conversion unit 7 outputs (displays, prints, etc.) the extracted IDs as screening results 8.

The database 6 stores information including a table that represents a correspondence between IDs and diffusion conditions (production conditions such as diffusion lot names, wafer numbers, and information about intra-wafer positions) associated with the IDs. The database 6 is stored in a storage unit (not illustrated) and is used to search for the diffusion conditions from the IDs and for the IDs from the diffusion conditions.

Next, an operation of the screening apparatus according to example 1 of the present invention will be described with reference to the drawings. FIG. 2 is a flow chart schematically illustrating an operation of the screening apparatus according to example 1 of the present invention.

First, the measurement unit (1 of FIG. 1) measures values (physical values) of all the DUTs (5 of FIG. 1) included in a lot and acquires measured values (physical values) and IDs (step A1). More specifically, in step A1, the measurement unit (1 of FIG. 1) applies a voltage, a current, and an electrical signal to the DUTs (5 of FIG. 1) electrically connected to the measurement unit (1 of FIG. 1) under predetermined conditions and measures values (physical values) such as an output voltage, an output current, and an output signal from the DUTs (5 of FIG. 1). In addition, the measurement unit (1 of FIG. 1) sets operation environments (the temperature, etc.) of the DUTs (5 of FIG. 1) to predetermined conditions. In parallel with measurement of these values (physical values), the measurement unit (1 of FIG. 1) reads numbers (IDs) each uniquely allocated to a DUT (5 of FIG. 1), associates the IDs with the measured values (physical values), and stores the associated data. During the measurement, the measurement unit (1 of FIG. 1) measures values (physical values) of a plurality of DUTs (5 of FIG. 1) by the lot as a unit.

Next, the measurement unit (1 of FIG. 1) evaluates the acquired measured values (physical values) based on predetermined criteria, and based on the evaluation results, determines quality of each of the DUTs (5 of FIG. 1) of the entire lot (step A2). In step A2, the measurement unit (1 of FIG. 1) associates the determination results with the IDs and stores the associated data. If the measured values satisfy criteria, the measurement unit determines that the corresponding DUT is positive, and if the measured values do not satisfy the criteria, the measurement unit determines that the corresponding DUT is negative.

Next, based on the IDs of all of the DUTs (5 of FIG. 1) included in the lot sent from the measurement unit (1 of FIG. 1), the conversion unit (2 of FIG. 1) accesses the database (6 of FIG. 1), extracts corresponding diffusion conditions for each of the IDs from the database (6 of FIG. 1), and associates the acquired diffusion conditions with corresponding measured values (physical values) and determination results (step A3).

Next, the measured-value reconstruction unit (3 of FIG. 1) classifies the measured values (physical values) of all the DUTs included in the lot sent from the conversion unit (2 of FIG. 1) according to the diffusion conditions. Namely, the measured-value reconstruction unit (3 of FIG. 1) groups the measured values according to the diffusion conditions and organizes the measured values (physical values) of the DUTs in each of the groups (step A4). Thus, while the DUTs 5 of the entire lot have different diffusion conditions before step A4, in step A4, the measured-value reconstruction unit (3 of FIG. 1) classifies the DUTs into groups according to the diffusion conditions. As a result, the measured values can be classified.

Next, after receiving information (a collection of pieces of information about the DUTs classified into groups according to the diffusion conditions) from the measured-value reconstruction unit (3 of FIG. 1), the evaluation and analysis unit (4 of FIG. 1) uses the information as a population and evaluates and analyzes the measured values (physical values) of the DUTs in a predetermined method, to determine DUTs (5 of FIG. 1) each exhibiting measured values that deviate from a distribution (exhibiting outliers) to be devices to be screened (step A5).

Next, the evaluation and analysis unit (4 of FIG. 1) sends information including the diffusion conditions of the DUTs (5 of FIG. 1) determined to be the devices to be screened. Based on the diffusion conditions, the inverse conversion unit (7 of FIG. 1) accesses the database (6 of FIG. 1) to acquire corresponding IDs (step A6).

Finally, the inverse conversion unit (7 of FIG. 1) outputs (displays, prints, etc.) the IDs of the DUTs (5 of FIG. 1) determined to be the devices to be screened as the results (8 of FIG. 1) (step A7).

According to example 1, the diffusion conditions (manufacturing conditions) are extracted based on the IDs of DUTs, measured values (physical values) of the DUTs are classified into groups according to the manufacturing conditions, and a distribution of measured values (physical values) is created for each group. In this way, since each of the distributions of the measured values (physical values) falls within a certain narrow range, a semiconductor device exhibiting measured values (physical values) that deviate from a distribution can be easily determined. Thus, high-precision screening of the DUTs is enabled.

If the measured values (physical values) of all the DUTs included in a single lot are used as a population for evaluation and analysis and if DUTs each exhibiting measured values (physical values) that deviate from a distribution are determined without classifying the measured values (physical values) according to the diffusion conditions, since the DUTs included in the single lot are likely to include devices with various diffusion conditions, each of the distributions of the measured values (physical values) often becomes widespread. Thus, since it is difficult to determine DUTs each exhibiting measured values (physical values) that deviate from a distribution, appropriate screening cannot be executed. In contrast, as in example 1, if the measured values (physical values) are classified according to the diffusion conditions, for example, if a distribution of measured values (physical values) of DUTs included in the same diffusion lot and manufactured on a chip of the same wafer is created, the distribution falls within a narrow range. Thus, since DUTs each exhibiting measured values (physical values) that deviate from a distribution can easily be determined, appropriate screening can be executed.

### EXAMPLE 2

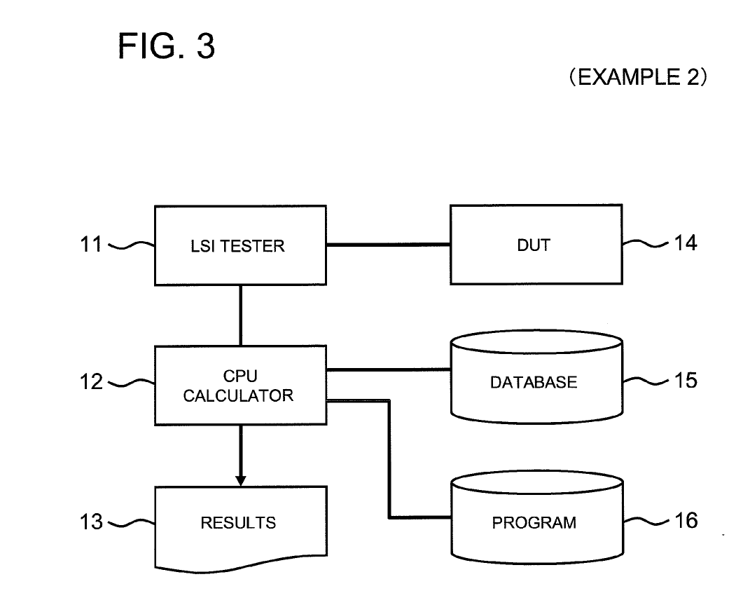

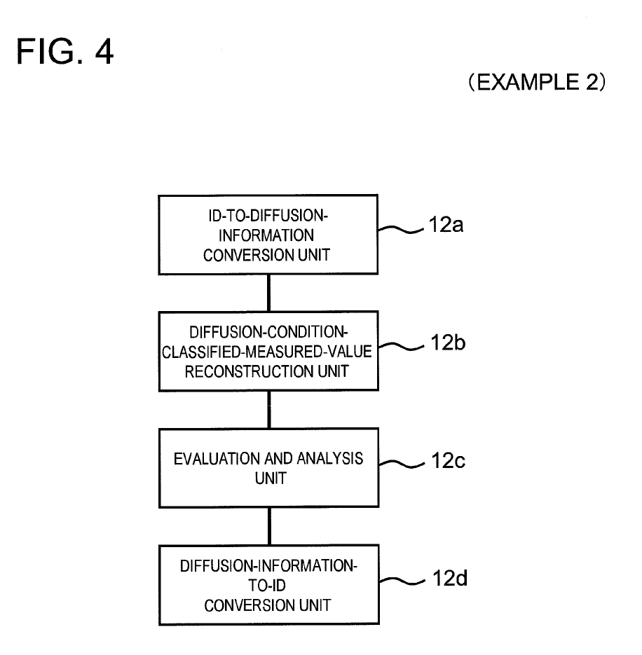

A screening apparatus according to example 2 of the present invention will be described with reference to the drawings. FIG. 3 is a block diagram schematically illustrating a configuration of the screening apparatus according to example 2 of the present invention. FIG. 4 is a block diagram schematically illustrating an internal configuration of a calculator of the screening apparatus according to example 2 of the present invention.

Example 2 is a variation of example 1, and the screening apparatus according to example 2 realizes the units (1 to 4 and 7 of FIG. 1) of the screening apparatus according to example 1 in another way. Namely, a large scale integration (LSI) tester 11 is used as the measurement unit (1 of FIG. 1), and a calculator 12 and a program 16 are used as the conversion unit (2 of FIG. 1), the measured-value reconstruction unit (3 of FIG. 1), the evaluation and analysis unit (4 of FIG. 1), and the inverse conversion unit (7 of FIG. 1). Other configurations are the same as those of example 1.

The LSI tester 11 is a measurement apparatus for measuring a voltage and a current of an integrated circuit such as an LSI (see FIG. 3). The LSI tester 11 is electrically connected to DUTs 14 via a probe or the like. The LSI tester 11 can apply a predetermined electrical signal, voltage, and current and can measure values (physical values) such as an electrical signal, a voltage value, and a current value. Further, the LSI tester 11 can set operation environments (the temperature, etc) of the DUTs 14. By measuring values (physical values) such as an output signal, an output voltage, and an output current from the DUTs 14 under such environments, the LSI tester 11 evaluates the measured values (physical values) of the DUTs 14. Based on results of the evaluation, the LSI tester 11 determines quality of each of the DUTs 14 of a lot. In addition, when evaluating and determining the DUTs 14, the LSI tester 11 can read an identification code (ID) uniquely allocated to each of the DUTs 14. The LSI tester 11 is connected to the calculator 12, so that the LSI tester 11 can communicate with the calculator 12. The LSI tester 11 sends the obtained measured values (physical values such as current values, voltage values, and frequencies) to the calculator 12, along with the IDs and the determination results.

The calculator 12 is a computer performing calculation and information processing by executing the program 16 based on the information sent from the LSI tester 11 (see FIG. 3). The calculator 12 is connected to the database 15 (a storage apparatus storing the database 15), so that the calculator 12 can communicate with the database 15. The calculator 12 can access to data in the database 15 and is connected to the program 16 (a storage apparatus storing the program 16), so that the calculator 12 can communicate with the program 16. The calculator 12 executes calculator programs of the program 16 and includes a storage apparatus (not illustrated). The results of the calculation executed by the calculator 12 are outputted (displayed, printed, etc) as results 13.

The calculator 12 executes the program 16 to realize an ID-to-diffusion-information conversion unit 12a, a diffusion conditions-classified measured-value reconstruction unit 12b, an evaluation and analysis unit 12c, and a diffusion-information-to-ID conversion unit 12d.

Based on the IDs sent from the LSI tester 11, the ID-to-diffusion-information conversion unit 12a extracts diffusion conditions associated with the IDs from the database 15, associates the extracted diffusion conditions with the measured values (physical values) and the determination results, and sends the associated data to the diffusion-condition-classified-measured-value reconstruction unit 12b.

Next, the diffusion-condition-classified-measured-value reconstruction unit 12b classifies (groups) the measured values (physical values) and the determination results sent from the ID-to-diffusion-information conversion unit 12a according to the diffusion conditions sent from the ID-to-diffusion-information conversion unit 12a. The diffusion-condition-classified-measured-value reconstruction unit 12b then sends the measured values (physical values) and the determination results classified according to the diffusion conditions to the evaluation and analysis unit 12c.

Next, the evaluation and analysis unit 12c analyzes the determination results and the measured values (physical values) classified according to the diffusion conditions and sent from the diffusion-condition-classified-measured-value reconstruction unit 12b, to determine DUTs 14 each exhibiting measured values (physical values) that deviate from a distribution. The evaluation and analysis unit 12c then sends DUT information (including diffusion conditions, determination results, and physical values) about the DUTs 14 each exhibiting measured values (physical values) that deviate from a distribution to the diffusion-information-to-ID conversion unit 12d.

Based on the DUT information sent from the evaluation and analysis unit 12c, the diffusion-information-to-ID conversion unit 12d searches the database 15 to extract corresponding IDs and outputs (displays, prints, etc.) the extracted IDs as the screening results 13.

Each of the DUTs 14 is a semiconductor device that has a unique number (ID) distinguishable from those of any other DUTs 14.

In addition, in the form of a correspondence table, the database 15 stores information about diffusion conditions set when the DUTs 14 having IDs are manufactured. The information includes unique diffusion lot numbers, wafer numbers, and intra-wafer positions, for example. Such information is used when the diffusion conditions are extracted based on the IDs or when the IDs are extracted based on the diffusion conditions.

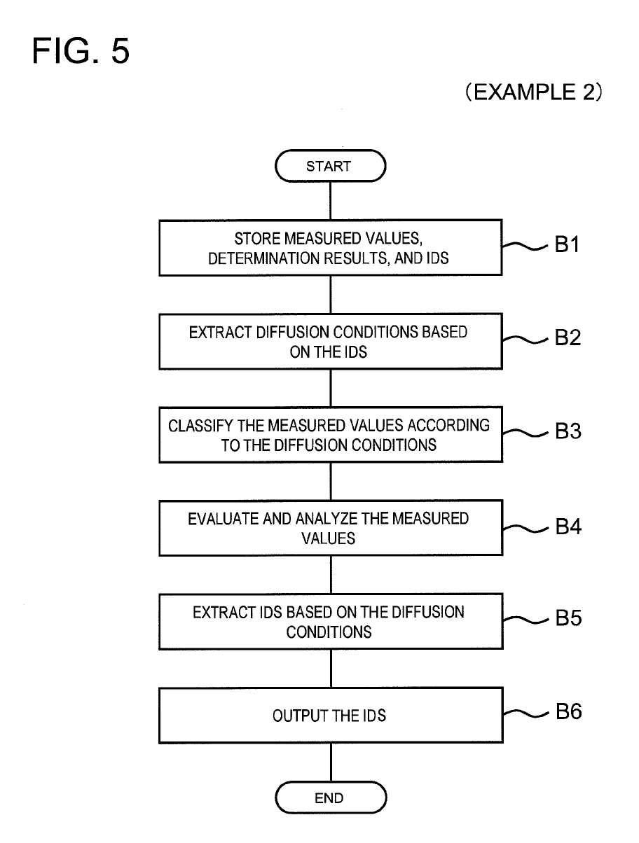

Next, an operation of the screening apparatus according to example 2 of the present invention will be described with reference to the drawings. FIG. 5 is a flow chart schematically illustrating an operation of the screening apparatus according to example 2 of the present invention.

First, the LSI tester (11 of FIG. 3) measures values (physical values) of all the DUTs (14 of FIG. 3) included in a lot and determines whether the measured values (physical values) fall within preset reference values (criteria). In this way, the LSI tester (11 of FIG. 3) determines quality of the DUTs (14 of FIG. 3). In addition, the LSI tester (11 of FIG. 3) reads the IDs allocated to the DUTs (14 of FIG. 3), associates the read IDs with the measured values (physical values) and the determination results of corresponding DUTs (14 of FIG. 3), and temporarily stores the associated data in a storage apparatus (not illustrated) included in the LSI tester (11 of FIG. 3) (step B1). For measurement, the LSI tester (11 of FIG. 3) applies a preset voltage, current, and electrical signal to the DUTs (14 of FIG. 3) and measures values (measured values) such as an output voltage, current, and signal from the DUTs. In addition, measurement environments (the temperature, etc.) during the measurement of the DUTs (14 of FIG. 3) are set/controlled by the LSI tester (11 of FIG. 3) or a different apparatus (not illustrated). These operations are executed on all the DUTs (14 of FIG. 3) in a set referred to as a lot. After measuring all the DUTs (14 of FIG. 3) included in a lot, the LSI tester (11 of FIG. 3) sends the measured values, the examination results, and the IDs of the DUTs (14 of FIG. 3) temporarily stored in the internal storage apparatus to the calculator (12 of FIG. 3).

Next, the ID-to-diffusion-information conversion unit (12a of FIG. 4) accesses the database (15 of FIG. 3) based on the IDs of all the DUTs (14 of FIG. 3) included in the lot sent from the LSI tester (11 of FIG. 3). The ID-to-diffusion-information conversion unit (12a of FIG. 4) extracts diffusion conditions corresponding to each of the IDs from the database (15 of FIG. 3) and associates the extracted diffusion conditions with corresponding measured values (physical values) and determination results (step B2).

Next, the diffusion-condition-classified-measured-value reconstruction unit (12b of FIG. 4) classifies the measured values (physical values) of all the DUTs included in the lot sent from the ID-to-diffusion-information conversion unit (12a of FIG. 4) according to the diffusion conditions (step B3). Namely, the diffusion-condition-classified-measured-value reconstruction unit (12b of FIG. 4) groups the measured values (physical values) according to the diffusion conditions and organizes the measured values (physical values) of the DUTs in each group. For example, DUTs included in the same diffusion lot and manufactured on the same wafer are classified into one group. The measured values, examination results, IDs, and the like of the classified DUTs are temporarily stored in the storage apparatus (not illustrated) included in the calculator (12 of FIG. 3).

Next, the evaluation and analysis unit (12c of FIG. 4) performs evaluation and analysis by using the measured values (physical values) classified according to the diffusion conditions and sent from the diffusion-condition-classified-measured-value reconstruction unit (12b of FIG. 4) as a population in a predetermined method. The evaluation and analysis unit (12c of FIG. 4) determines DUTs each exhibiting values that deviate from a measured value (physical value) distribution to be DUTs to be screened (step B4).

Next, the diffusion-information-to-ID conversion unit (12d of FIG. 4) accesses the database (15 of FIG. 3) based on the diffusion conditions of the DUTs (14 of FIG. 3) to be screened included in the information sent from the evaluation and analysis unit (12c of FIG. 4), to acquire corresponding IDs (step B5).

Finally, the diffusion-information-to-ID conversion unit (12d of FIG. 4) outputs (displays, prints, etc.) the corresponding IDs of the DUTs (14 of FIG. 3) to be screened as the results (13 of FIG. 3) (step B6).

While the calculator (12 of FIG. 3) executes calculator control programs included in the program (16 of FIG. 3) to execute steps B2 to B6, these steps B2 to B6 may be executed by hardware.

Example 2 provides similar meritorious effects as those provided by example 1.

### EXAMPLE 3

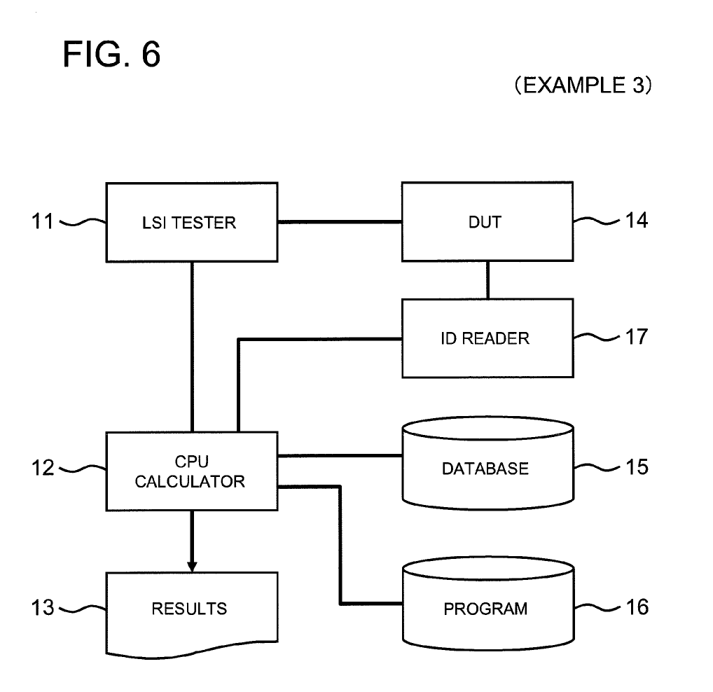

A screening apparatus according to example 3 of the present invention will be described with reference to the drawings. FIG. 6 is a block diagram schematically illustrating a configuration of the screening apparatus according to example 3 of the present invention.

The screening apparatus according to example 3 is a variation of the screening apparatus according to example 2 (see FIG. 3). In addition to the components of the screening apparatus according to example 2, the screening apparatus according to example 3 includes an ID reader 17. In example 2, the LSI tester (11 of FIG. 3) reads the IDs of the DUTs 14. However, in example 3, the added ID reader 17 reads the IDs of the DUTs 14. The ID reader 17 electrically or optically reads the IDs allocated to the DUTs 14 and sends the read IDs to the calculator 12. The calculator 12 associates measured values (physical values) of the DUTs 14 sent from the LSI tester 11 with the IDs sent from the ID reader 17. Other configurations are the same as those of example 2.

Example 3 provides similar meritorious effects as those provided by example 2.

### EXAMPLE 4

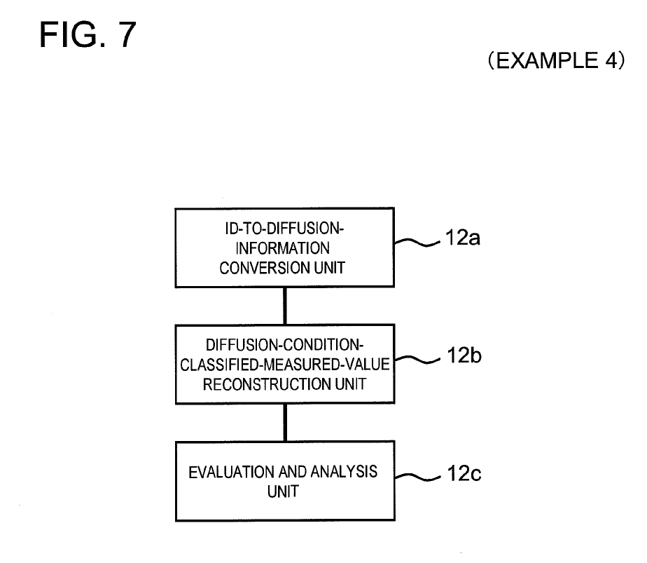

A screening apparatus according to example 4 of the present invention will be described with reference to the drawings. FIG. 7 is a block diagram schematically illustrating an internal configuration of a calculator of a screening apparatus according to example 4 of the present invention.

The screening apparatus according to example 4 is a variation of the screening apparatus according to example 2. When compared with the units (12a to 12d of FIG. 4) of the calculator (12 of FIG. 3) of the screening apparatus according to example 2, the calculator according to example 4 lacks the diffusion-information-to-ID conversion unit (12d of FIG. 4). Since the diffusion conditions, the measured values, and the determination results are associated with the IDs, the calculator does not necessarily need to access the database (15 of FIG. 3) according to example 2 to extract IDs based on the diffusion conditions. Thus, in example 4, the calculator 12 does not access the database (15 of FIG. 3) to extract IDs of the DUTs based on the diffusion conditions. The calculator 12 can extract IDs based on the diffusion conditions associated with the IDs, without accessing the database. In example 4, the evaluation and analysis unit 12c outputs (displays, prints, etc.) the IDs of the DUTs to be screened as the screening results (13 of FIG. 3). Other configurations are the same as those of example 2.

Example 4 provides similar meritorious effects as those provided by example 2.

### EXAMPLE 5

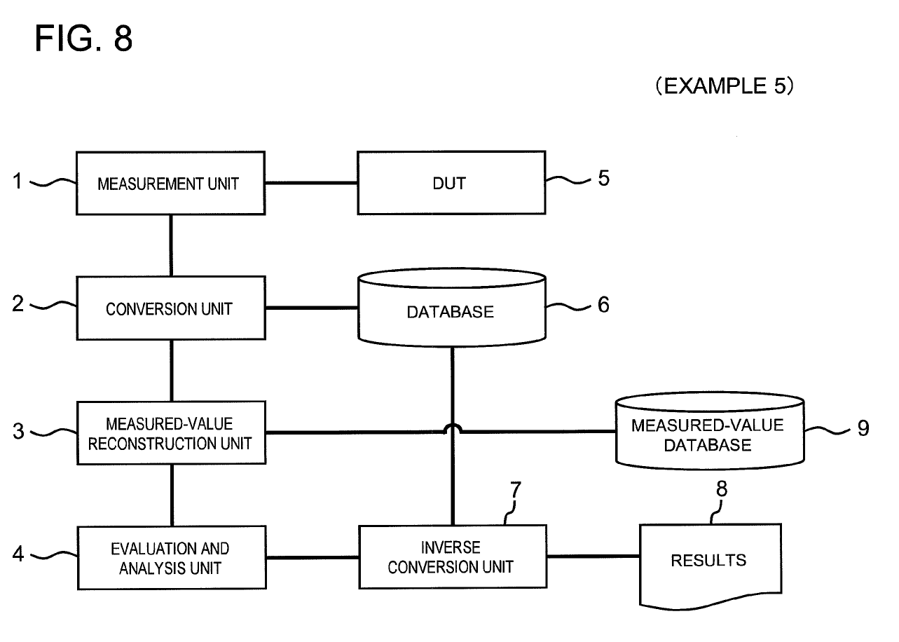

A screening apparatus according to example 5 of the present invention will be described with reference to the drawings. FIG. 8 is a block diagram schematically illustrating a configuration of the screening apparatus according to example 5 of the present invention.

The screening apparatus according to example 5 is a variation of the screening apparatus according to example 1. When compared with the screening apparatus according to example 1 (see FIG. 1), the screening apparatus according to example 5 additionally includes a measured-value database 9 (a storage unit (not illustrated) storing the measured-value database 9) connected to the measured-value reconstruction unit 3 so that the measured-value reconstruction unit 3 can communicate with the measured-value database 9. Other configurations are the same as those of example 1.

The measured-value database 9 includes a database established based on IDs. More specifically, the measured-value database 9 stores measured values (physical values), determination results, diffusion conditions, and IDs of the DUTs 5 obtained in the past. The measured-value reconstruction unit 3 is connected to the storage unit (not illustrated) storing the above information, so that the measured-value reconstruction unit 3 can communicate with the storage unit.

The measured-value reconstruction unit 3 sends the diffusion conditions, the measured values (physical values), the determination results, and the IDs sent from the conversion unit 2 to the measured-value database 9 and updates the database in the measured-value database 9. Further, the measured-value reconstruction unit 3 acquires necessary data (physical values, determination results, diffusion conditions, and IDs) from the measured-value database 9, classifies the acquired data according to the diffusion conditions, and sends the classified data to the evaluation and analysis unit 4.

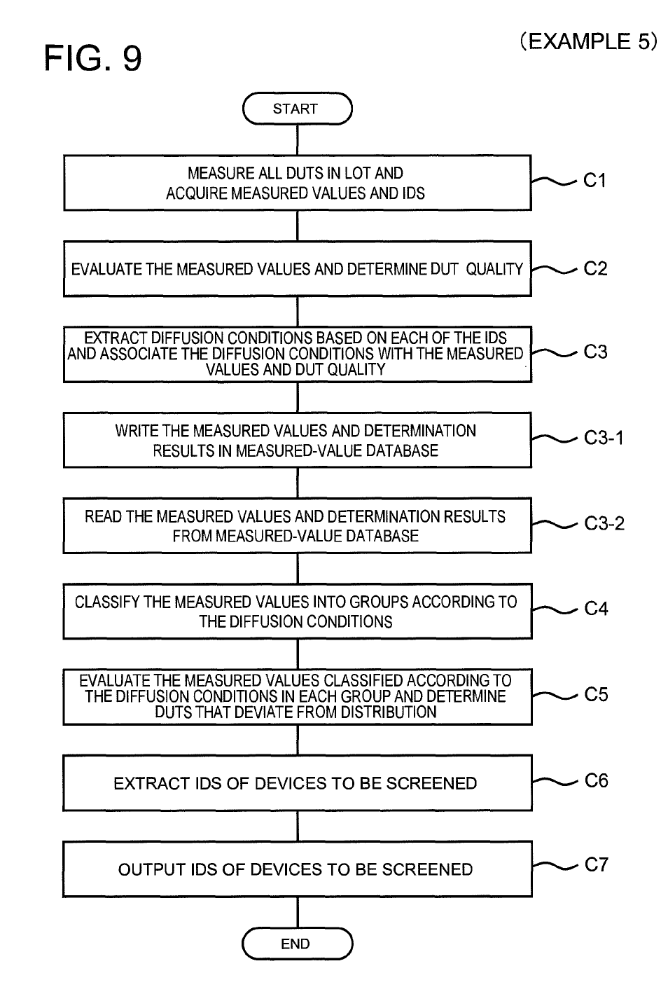

Next, an operation of the screening apparatus according to example 5 of the present invention will be described with reference to the drawings. FIG. 9 is a flow chart schematically illustrating an operation of the screening apparatus according to example 5 of the present invention.

First, the measurement unit (1 of FIG. 8) measures values (physical values) of all the DUTs (5 of FIG. 8) included in a lot and acquires measured values (physical values) and IDs (step C1). Step C1 is the same as step A1 (see FIG. 2) of example 1.

Next, the measurement unit (1 of FIG. 8) evaluates the acquired measured values (physical values) based on predetermined criteria, and based on the evaluation results, determines quality of each of the DUTs (5 of FIG. 8) of the entire lot (step C2). Step C2 is the same as step A2 (see FIG. 2) of example 1.

Next, based on the IDs of all of the DUTs (5 of FIG. 8) included in the lot sent from the measurement unit (1 of FIG. 8), the conversion unit (2 of FIG. 8) accesses the database (6 of FIG. 8), acquires corresponding diffusion conditions for each of the IDs from the database (6 of FIG. 8), and associates the acquired diffusion conditions with corresponding measured values (physical values) and determination results (step C3). Step C3 is the same as step A3 (see FIG. 2) of example 1.

Next, the measured-value reconstruction unit (3 of FIG. 8) sends the measured values (physical values) of all the DUTs included in the lot sent from the conversion unit (2 of FIG. 8) to the measured-value database (9 of FIG. 8), along with the diffusion conditions and the IDs (step C3-1). In this way, the measured value and the like are added in the database established in the measured-value database (9 of FIG. 8) (the database is updated).

Next, based on the diffusion conditions, the measured-value reconstruction unit (3 of FIG. 8) reads the measured values (physical values) and the determination results of all the DUTs (5 of FIG. 8) included in the lot from the measured-value database (9 of FIG. 8) (step C3-2).

Next, the measured-value reconstruction unit (3 of FIG. 8) classifies the measured values (physical values) of all the DUTs included in the lot read from the measured-value database (9 of FIG. 8) according to the diffusion conditions. Namely, the measured-value reconstruction unit (3 of FIG. 8) groups the measured values according to the diffusion conditions and organizes the measured values (physical values) of the DUTs in each of the groups (step C4). Thus, while the DUTs of the entire lot have different diffusion conditions before step C4, in step C4, the measured-value reconstruction unit (3 of FIG. 8) uses not only the DUTs included in the measured lot but also other lots measured in the past and classifies all the DUTs according to the diffusion conditions. As a result, the measured values can be classified.

Next, after receiving information (a collection of pieces of information about the DUTs classified into groups according to the diffusion conditions) from the measured-value reconstruction unit (3 of FIG. 8), the evaluation and analysis unit (4 of FIG. 8) uses the information as a population and evaluates and analyzes the measured values (physical values) of the DUTs in a predetermined method. In this way, the evaluation and analysis unit (4 of FIG. 8) determines DUTs (5 of FIG. 8) each exhibiting measured values that deviate from a distribution (DUTs exhibiting outliers) to be devices to be screened (step C5). Step C5 is the same as step AS (see FIG. 2) of example 1.

Next, the evaluation and analysis unit (4 of FIG. 8) sends information including the diffusion conditions of the DUTs (5 of FIG. 8) determined to be the devices to be screened to the inverse conversion unit (7 of FIG. 8). Based on the diffusion conditions, the inverse conversion unit (7 of FIG. 8) accesses the database (6 of FIG. 8) to acquire corresponding IDs (step C6). Step C6 is the same as step A6 (see FIG. 2) of example 1.

Finally, the inverse conversion unit (7 of FIG. 8) outputs (displays, prints, etc.) the IDs of the DUTs (5 of FIG. 8) determined to be the devices to be screened as the results (8 of FIG. 8) (step C7). Step C7 is the same as step A7 (see FIG. 2) of example 1.

According to example 5, measured values of all the DUTs (5 of FIG. 8) included in the currently measured lot are combined together with measured values of the DUTs measured in the past and classified according to the diffusion conditions. These combined measured values are then evaluated and analyzed. In this way, when compared with screening executed by evaluating and analyzing only the measured values of the DUTs included in the currently measured lot, screening can be executed with higher accuracy. If all the DUTs included in the currently measured lot are classified according to the diffusion conditions, the size of the population (the number of the DUTs) is not large. However, there is a possibility that DUTs classified according to the diffusion conditions are included in a previously measured lot other than the currently measured lot. If so, since a database of the measured-value database (9 of FIG. 8) stores measured values of such DUTs, by evaluating and analyzing both the DUTs included in the previously measured lot and the DUTs included in the currently measured lot, the population size is made greater, compared with that of only the DUTs included in the currently measured lot. Particularly, it is expected that the larger the population size is, more accurate the profile of the measured-value distribution will be. Thus, if such a screening technique as provided by the present invention, which involves determining measured values that deviate from a distribution, is used, screening can be executed with higher accuracy.

### EXAMPLE 6

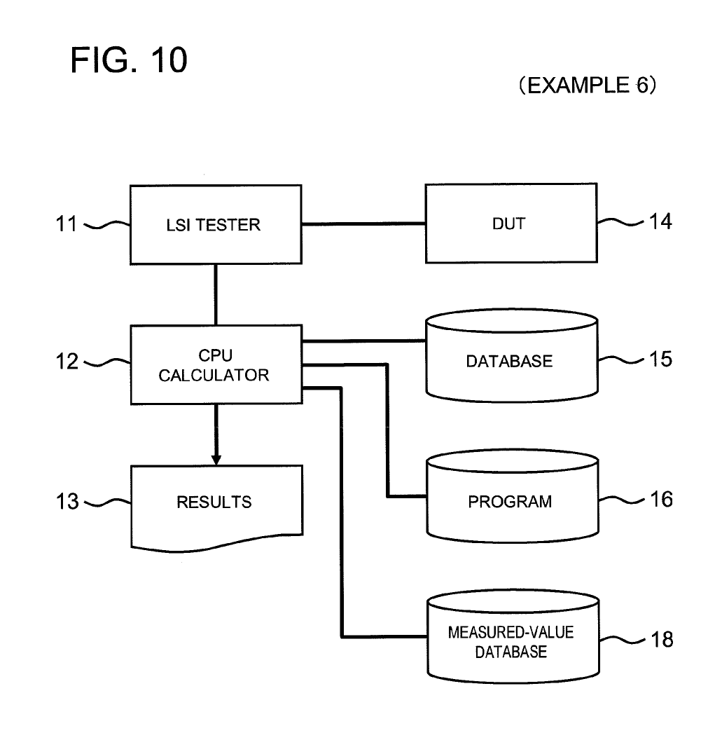

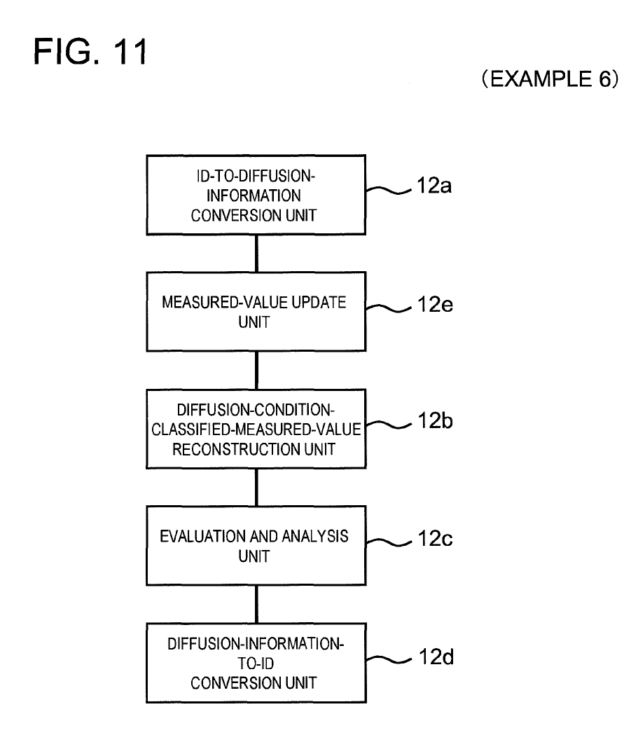

A screening apparatus according to example 6 of the present invention will be described with reference to the drawings. FIG. 10 is a block diagram schematically illustrating a configuration of the screening apparatus according to example 6 of the present invention. FIG. 11 is a block diagram schematically illustrating an internal configuration of a calculator of the screening apparatus according to example 6 of the present invention.

Example 6 is a variation of example 5, and the screening apparatus according to example 6 realizes the units (1 to 4 and 7 of FIG. 8) of the screening apparatus according to example 5 in another way. Namely, example 6 is the same as example 2, except that an LSI tester 11 is used as the measurement unit (1 of FIG. 8), and a calculator 12 and a program 16 are used as the conversion unit (2 of FIG. 8), the measured-value reconstruction unit (3 of FIG. 8), the evaluation and analysis unit (4 of FIG. 8), and the inverse conversion unit (7 of FIG. 8). In addition to the components of the screening apparatus (see FIG. 3) according to example 2, the screening apparatus according to example 6 further includes a measured-value database 18. Furthermore, in addition to the units (see FIG. 4) of the calculator (12 of FIG. 3) according to example 2, the calculator 12 according to example 6 further includes a measured-value update unit 12e. Other configurations are the same as those of example 2.

The calculator 12 is connected to the measured-value database (a storage apparatus storing the measured-value database 18) storing previously measured physical values as a database, so that the calculator 12 can communicate with the measured-value database 18. The calculator 12 can freely access the measured-value database 18. The calculator 12 executes the program 16 to realize the ID-to-diffusion-information conversion unit 12a, the measured-value update unit 12e, the diffusion-condition-classified-measured-value reconstruction unit 12b, the evaluation and analysis unit 12c, and the diffusion-information-to-ID conversion unit 12d.

The measured-value update unit 12e sends the diffusion conditions, the measured values (physical values), the determination results, and the IDs sent from the ID-to-diffusion-information conversion unit 12a to the measured-value database 18 and updates the database in the measured-value database 18. Next, the diffusion-condition-classified-measured-value reconstruction unit 12b extracts necessary data (physical values, determination results, diffusion conditions, and IDs) from the measured-value database 18. Based on the diffusion conditions included in the acquired data, the diffusion-condition-classified-measured-value reconstruction unit 12b then classifies (groups) the measured values (physical values) and the determination results included in the acquired data according to the diffusion conditions and sends the measured values (physical values) and the determination results classified according to the diffusion conditions to the evaluation and analysis unit 12c.

Other functions and units in the calculator 12 are the same as those of the calculator (12 of FIG. 3) according to example 2.

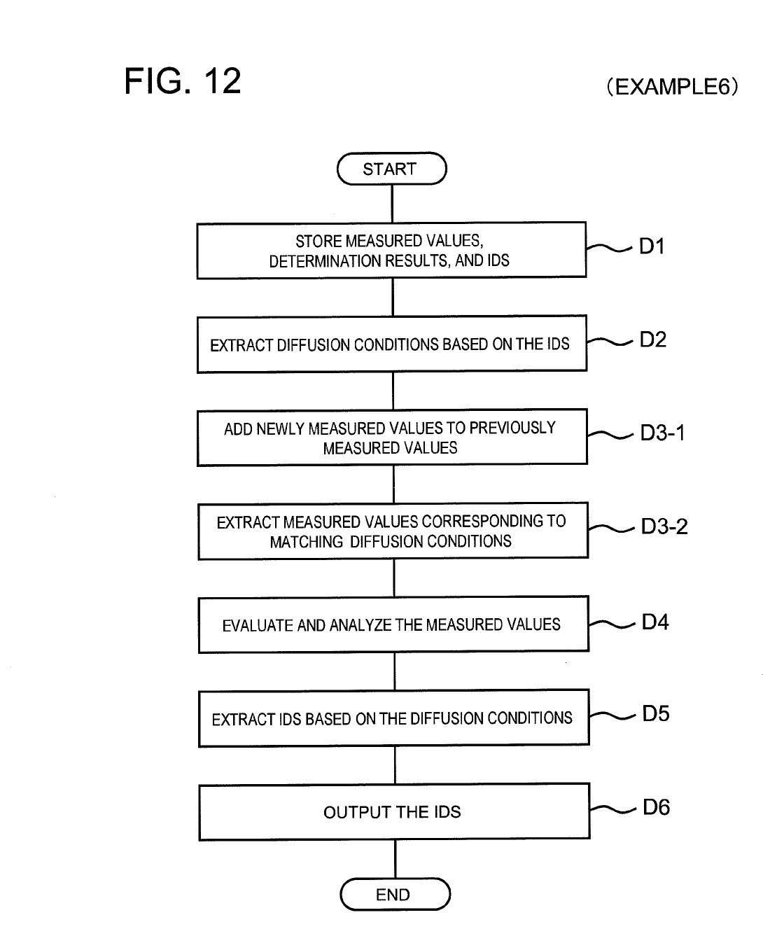

Next, an operation of the screening apparatus according to example 6 of the present invention will be described with reference to the drawings. FIG. 12 is a flow chart schematically illustrating an operation of the screening apparatus according to example 6 of the present invention.

First, the LSI tester (11 of FIG. 10) measures values (physical values) of all the DUTs (14 of FIG. 10) included in a lot and determines whether the measured values (physical values) fall within preset reference values (criteria). In this way, the LSI tester (11 of FIG. 10) determines quality of the DUTs (14 of FIG. 10). In addition, the LSI tester (11 of FIG. 10) reads the IDs allocated to the DUTs (14 of FIG. 10), associates the read IDs with the measured values (physical values) and the determination results of corresponding DUTs (14 of FIG. 10), and temporarily stores the associated data in a storage apparatus (not illustrated) included in the LSI tester (11 of FIG. 10) (step D1). Step D1 is the same as step B1.

Next, the ID-to-diffusion-information conversion unit (12a of FIG. 11) accesses the database (15 of FIG. 10) based on the IDs of all the DUTs (14 of FIG. 10) included in the lot sent from the LSI tester (11 of FIG. 10). The ID-to-diffusion-information conversion unit (12a of FIG. 11) extracts diffusion conditions corresponding to each of the IDs from the database (15 of FIG. 10) and associates the extracted diffusion conditions with corresponding measured values (physical values) and determination results (step D2). Step D2 is the same as step B2.

Next, the measured-value update unit (12e of FIG. 11) sends the diffusion information, the measured values, the IDs, and the like sent from the ID-to-diffusion-information conversion unit (12a of FIG. 11) to the measured-value database (18 of FIG. 10) and adds the above data in the database established in the measured-value database (18 of FIG. 10) (step D3-1).

Next, the diffusion-condition-classified-measured-value reconstruction unit (12b of FIG. 11) extracts measured values, determination results, IDs, and the like of DUTs having diffusion conditions matching the diffusion conditions of the DUTs included in the currently measured lot from the measured-value database (18 of FIG. 10). The diffusion-condition-classified-measured-value reconstruction unit (12b of FIG. 11) then classifies the measured values of the DUTs according to the diffusion conditions in a predetermined method (step D3-2). The DUTs include not only the DUTs included in the currently measured lot but also the previously measured DUTs having diffusion conditions identical to those of the DUTs included in the currently measured lot. The diffusion-condition-classified-measured-value reconstruction unit (12b of FIG. 11) groups the measured values (physical values) according to the diffusion conditions and organizes the measured values (physical values) of the DUTs in each group. For example, DUTs included in the same diffusion lot and manufactured on the same wafer are classified into one group. The measured values, examination results, IDs, and the like of the classified DUTs are temporarily stored in the storage apparatus (not illustrated) included in the calculator (12 of FIG. 10).

Next, the evaluation and analysis unit (12c of FIG. 11) performs evaluation and analysis by using the measured values (physical values) classified according to the diffusion conditions and sent from the diffusion-condition-classified-measured-value reconstruction unit (12b of FIG. 11) as a population in a predetermined method. The evaluation and analysis unit (12c of FIG. 11) determines DUTs each exhibiting values that deviate from a measured value (physical value) distribution to be DUTs to be screened (step D4). Step D4 is the same as step B4.

Next, the diffusion-information-to-ID conversion unit (12d of FIG. 11) accesses the database (15 of FIG. 10) based on the diffusion conditions of the DUTs (14 of FIG. 10) to be screened included in the information sent from the evaluation and analysis unit (12c of FIG. 11), to acquire corresponding IDs (step D5). Step D5 is the same as step B5.

Finally, the diffusion-information-to-ID conversion unit (12d of FIG. 11) outputs (displays, prints, etc.) the corresponding IDs of the DUTs (14 of FIG. 10) to be screened as the results (13 of FIG. 10) (step D6). Step D6 is the same as step B6.

While the calculator (12 of FIG. 10) executes calculator control programs included in the program (16 of FIG. 10) to execute steps D2 to D6, these steps D2 to D6 may be executed by hardware.

Example 6 provides similar meritorious effects as those provided by example 5.

Modifications and adjustments of the exemplary embodiments and examples are possible within the scope of the overall disclosure (including claims) of the present invention and based on the basic technical concept of the invention. Various combinations and selections of various disclosed elements are possible within the scope of the claims of the present invention. That is, the present invention of course includes various variations and modifications that could be made by those skilled in the art according to the overall disclosure including the claims and the technical concept.

What is claimed is:

1. A screening apparatus comprising:
a measurement unit measuring characteristics of a semiconductor device and reading an identification code allocated to the semiconductor device;
a database storing a table representing a correspondence between an identification code and a fabrication condition of a semiconductor device;
a conversion unit extracting, based on the identification code sent from the measurement unit, a fabrication condition associated with the identification code from the database and associating the extracted fabrication condition with the characteristics corresponding to the fabrication condition;
a characteristics reconstruction unit classifying the characteristics according to the fabrication condition sent from the conversion unit; and
an evaluation and analysis unit evaluating and analyzing the characteristics classified by the characteristics reconstruction unit according to the fabrication condition in a predetermined manner and determining a semiconductor device to be screened.

2. The screening apparatus according to claim 1, further comprising:
an inverse conversion unit extracting, based on the fabrication condition of the semiconductor device to be screened determined by the evaluation and analysis unit, a corresponding identification code associated with the fabrication condition from the database and outputting the extracted identification code.

3. The screening apparatus according to claim 1,
wherein the conversion unit associates the extracted fabrication condition with the characteristics and the identification code corresponding to the extracted fabrication condition;
wherein the characteristics reconstruction unit classifies the characteristics and the identification code according to the fabrication condition; and
wherein the evaluation and analysis unit outputs an identification code of the determined semiconductor device to be screened.

4. The screening apparatus according to claim 1,
wherein the measurement unit comprises a measurement apparatus measuring characteristics of the semiconductor device and a reader reading an identification code allocated to the semiconductor device.

5. The screening apparatus according to claim 1,
wherein the evaluation and analysis unit analyzes the characteristics classified according to the fabrication conditions and determines a semiconductor device exhibiting characteristics that deviate from a distribution to be a semiconductor device to be screened.

6. The screening apparatus according to claim 1,
wherein at least the conversion unit, the characteristics reconstruction unit, and the evaluation and analysis unit are realized by a calculator executing a program.

7. The screening apparatus according to claim 1, further comprising:
a second database storing characteristics and a fabrication condition of a past semiconductor device,
wherein the characteristics reconstruction unit sends the characteristics and the fabrication condition sent from the conversion unit to the second database and updates data in the second database.

8. The screening apparatus according to claim 7,
wherein the characteristics reconstruction unit extracts necessary data from the second database and classifies the characteristics according to the fabrication condition based on the extracted necessary data.

9. A screening method comprising:
measuring characteristics of a semiconductor device and reading an identification code allocated to the semiconductor device;
extracting, based on the read identification code, a fabrication condition associated with the identification code from a database storing a table representing a correspondence between an identification code and a fabrication condition of a semiconductor device and associating the extracted fabrication condition with the characteristics corresponding to the fabrication condition;
classifying the characteristics according to the fabrication condition; and
evaluating and analyzing the characteristics classified according to the fabrication condition in a predetermined manner and determining a semiconductor device to be screened.

10. The method according to claim 9, further comprising:
adding the characteristics and the fabrication condition to the second database between associating the fabrication condition with the characteristics corresponding to the fabrication condition and classifying the characteristics.

11. A program causing a calculator to execute:
measuring characteristics of a semiconductor device, reading an identification code allocated to the semiconductor device, extracting, based on the read identification code, a fabrication condition associated with the identification code from a database storing a table representing a correspondence between an identification code and a fabrication condition of a semiconductor device, and associating the extracted fabrication condition with the characteristics corresponding to the fabrication condition;
classifying the characteristics according to the fabrication condition; and
evaluating and analyzing the characteristics classified according to the fabrication condition in a predetermined manner and determining a semiconductor device to be screened.

12. The program according to claim 11, wherein said program causes the calculate to execute further comprising:
adding the characteristics and the fabrication condition to the second database between associating the fabrication condition with the characteristics corresponding to the fabrication condition and classifying the characteristics.
